(19) United States
(12) Patent Application Publication
(10) Pub. No.: US 2007/0272650 A1
(43) Pub. Date: Nov. 29, 2007

(54) Container Stopper and Manufacturing Method Therefor

(75) Inventors: Shigenobu Kishi, Kanagawa (JP); Masaru Okamoto, Okayama (JP); Katsuya Fujimoto, Okayama (JP)

Correspondence Address: THE WEBB LAW FIRM, P.C., 700 KOPPERS BUILDING, 436 SEVENTH AVENUE, PITTSBURGH, PA, 15219, US

(73) Assignees: SUNTORY LIMITED, OSAKA (JP); UCHIYAMA MANUFACTURING CORP., OKAYAMA (JP)

(21) Appl. No.: 10/588,593

(22) PCT Filed: Feb. 8, 2005
(86) PCT No.: PCT/JP05/01806

§ 371 Date: Jun. 11, 2007

(30) Foreign Application Priority Data
Feb. 13, 2004 (JP) 2004-036540

(51) Int. Cl. B65D 39/18; B29C 51/12; B29C 63/04; B29C 65/40; B65D 39/04

(52) U.S. Cl. 215/364; 264/45.5

(57) ABSTRACT

A container stopper includes a core formed of an elastic material and having a liquid-contact surface and an outer peripheral surface continuous with the liquid-contact surface coated with a skin made of a synthetic resin. The skin is a skin made of a polyester resin or a synthetic resin having a polyester resin as a main component thereof, and the polyester skin is bonded to the liquid-contact surface and the outer peripheral surface of said core through a bonding layer formed of a polyethylene resin or having a polyethylene resin as a main component thereof. The polyethylene bonding layer has a thickness of 80 to 300 μm at a center portion of the liquid-contact surface, a thickness of 70 to 100 μm at an outer peripheral portion of the outer peripheral surface adjacent the liquid-contact surface and a thickness of 30 μm or more over the entire liquid-contact surface.

### TECHNICAL FIELD

The present invention relates to a container stopper, and a manufacturing method therefor, in which a liquid-contact surface and an outer peripheral surface continuous with the liquid-contact surface of a core formed of an elastic material are coated with a synthetic resin skin.

### BACKGROUND ART

As stoppers used for containers of whiskey and wine, for example, compressed cork stoppers, which are formed by blending an adhesive to cork grain made to an appropriate grain size, then heating and pressurizing it to form a compressed cork plate or compressed cork material, and punching or cutting it to a desired shape, and natural cork stoppers, are widely used conventionally.

However, with the conventional cork stoppers, although surface treatment is done with wax, silicone oil or the like, the cork is in a bare state. Therefore, when the cork is contaminated by mold smelling substances, typically trichloro-anisole (TCA), they could diffuse into the whiskey or wine in the containers to spoil the taste of the contents. In addition, cork dust could fall into the contents.

Furthermore, the contents could soak into the cells of the cork to discolor the outer surfaces of the cork stoppers. Where the contents contain alcohol, lignin and suberin which are components of the cork could diffuse to the alcohol, causing the cork stoppers to become “thin”, thereby lowering their physical strength and sealing effect.

Then, there has been proposed a container stopper in which a liquid-contact surface and an outer peripheral surface continuous with the liquid-contact surface of a core formed of a natural cork or compressed cork are coated with a synthetic resin skin (see e.g. Japanese Utility Model Application “Kokai” No. 59-112746, referred to as Patent Document 1 hereinafter).

Also, a container stopper has been proposed in which the liquid-contact surface and the outer peripheral surface continuous with the liquid-contact surface of the cork core are coated with a polyethylene skin and only the liquid-contact portion of the polyethylene skin is coated with a circular sheet made of polyethylene terephthalate (see e.g. Japanese Patent No. 2973249, referred to as Patent Document 2 hereinafter).

Patent Document 1: Japanese Utility Model Application “Kokai” No. 59-112746

Patent Document 2: Japanese Patent No. 2973249

### DISCLOSURE OF THE INVENTION

### Problem to be Solved by Invention

According to these conventional techniques, the above-mentioned problems such as of trichloro-anisole contained in the cork diffusing into the contents and the falling of cork dust are avoided. However, with the conventional technique described in Patent Document 1, there are disclosed no further problems or solutions therefor. Also, with the conventional technique described in Patent Document 2, the flavor of the contents could be spoiled by various types of smells entering from outside the container or by absorption or adsorption of the flavor of the contents.

That is, in the case of the conventional technique described in Patent Document 2, although the liquid-contact surface of the core is coated with a sheet of polyethylene terephthalate, the outer peripheral surface of the core, i.e. the portion that contacts the inner peripheral surface of the opening of the container, is coated with a skin of polyethylene. Since polyethylene is porous and has a property of absorbing and adsorbing smell, when stored in a warehouse, closet or the like, mold smelling substances, typically TCA, present in such an environment, and smell components such as naphthalene contained in an insecticide, could pass between the inner peripheral surface of the opening of the container and the stopper to be absorbed or adsorbed by the polyethylene to adversely affect the taste of the contents with the progress of time. Conversely, the flavor of the contents may be absorbed or adsorbed by the polyethylene, which would adversely affect the taste of the contents. There is room for improvement in this respect.

Naturally, a container stopper, when inserted into the opening of a container, is required to have a function for completely preventing leakage of the contents. However, where only the outer peripheral surface of the core is coated with a skin of polyethylene terephthalate to solve the above-noted problem, a reduction in diameter of the core inserted into the opening of the container results in “creases” being formed on the skin of polyethylene terephthalate covering the peripheries. The “creases” become a cause of leakage of the contents.

This invention has been made having regard to the disadvantages of the prior art noted above, and its object is to provide a container stopper, and a manufacturing method therefor, capable of reliably preventing adverse influences of various smells entering from outside the container and absorption and adsorption of the flavor of the content, as well as preventing adverse influences of a core such as cork.

### Solutions

According to the first characterizing feature of the present invention, a container stopper comprises a core formed of an elastic material and having a liquid-contact surface and an outer peripheral surface continuous with the liquid-contact surface, the liquid-contact surface and the outer peripheral surface being coated with a skin made of a synthetic resin, wherein said skin is a polyester skin made of a polyester resin or a synthetic resin having a polyester resin as a main component thereof, and the polyester skin is bonded to the liquid-contact surface and the outer peripheral surface of said core through a polyethylene bonding layer formed of a polyethylene resin or having a polyethylene resin as a main component thereof; and said polyethylene bonding layer has a thickness of 80 to 300 μm at a center portion of the liquid-contact surface, a thickness of 70 to 100 μm at an outer peripheral portion of the outer peripheral surface adjacent the liquid-contact surface and a thickness of 30 μm or more over the entire liquid-contact surface.

With the first characterizing feature of the present invention, the liquid-contact surface and the outer peripheral surface continuous with the liquid-contact surface of the core formed of an elastic material are coated with a polyester skin made of a polyester resin or a synthetic resin having a polyester resin as a main component thereof. Even where cork is used as the core, there is no possibility of undergoing adverse influences of the core, or adversely affecting the core itself, such as the taste of the contents being spoiled by diffusion of trichloro-anisole contained in the cork. Unlike polyethylene, the polyester resin does not have a property of absorbing or adsorbing smells, and can therefore prevent adverse influences on the contents by entry of various smells from outside the container and absorption and adsorption of the flavor of the contents.

And, since the polyester skin is bonded to the liquid-contact surface and the outer peripheral surface of said core through a polyurethane bonding layer formed of a polyethylene resin or having a polyethylene resin as a main component thereof, the core and the polyester skin are completely integrated. Even if the core reduces in diameter when inserted into the opening of the container, the polyester skin follows the core to shrink alike, thereby avoiding “creases”.

In addition, since said polyethylene bonding layer has a thickness of 80 to 300 μm at a center portion of the liquid-contact surface, a thickness of 70 to 100 μm at an outer peripheral portion of the outer peripheral surface adjacent the liquid-contact surface and a thickness of 30 μm or more over the entire liquid-contact surface, as will be detailed later, even where cork is used as the core and there exist fine recesses unique to cork in the surface of the cork core, in particular, in the liquid-contact surface, it is possible to avoid formation of pinholes in the polyester skin due to such recesses, and “creases” in the outer peripheral surface of the core can be reliably avoided also.

As a result, the liquid-contact surface and the outer peripheral surface of the core may be coated with the skin made of a polyester resin without impairing the functions required of the container stopper. This prevents adverse influences on the contents by entry of various smells from outside the container and absorption and adsorption of the flavor of the contents, as well as adverse influences of the core, as noted hereinbefore. Even where the content includes alcohol, alcohol barrier characteristics of the polyester resin can prevent diffusion of core components to alcohol, to prevent a volume reduction of the core.

The “synthetic resin having a polyester resin as a main component thereof” herein does not mean that, for example, the polyester resin included is in 50% or more, but means that the polyester resin is included in an amount sufficient for the above-noted functions and effects to be expected. This also applies to the description “polyethylene bonding layer having a polyethylene resin as a main component thereof”. That is, this means that the ethylene resin is included in an amount sufficient for the above-noted functions and effects to be expected.

According to the second characterizing feature of the present invention, in the container stopper described above, the thickness of said polyethylene bonding layer is 10 μm or more greater than the thickness of the polyethylene bonding layer at the outer peripheral portion.

With the second characterizing feature of the present invention, since the thickness of said polyethylene bonding layer is 10 μm or more greater than the thickness of the polyethylene layer at the outer peripheral portion, as will become apparent from experiment results to be described later, as long as such condition is met, even where there exist fine recesses in the surface of the cork core, it is possible to avoid more reliably formation of pinholes in the polyester skin due to such recesses, and “creases” in the outer peripheral surface of the core can be reliably avoided also.

According to the third characterizing feature of the present invention, in the container stopper described above, the polyethylene bonding layer at the liquid-contact surface comprises two layers and the polyethylene bonding layer at the outer peripheral surface comprises a one layer.

With the third characterizing feature of the present invention, since the polyethylene bonding layer at the liquid-contact surface comprises two layers, even where there exist fine recesses in the surface of the cork core, the polyethylene bonding layer on the inner side will enter the recesses and the polyethylene bonding layer on the outer side will provide the original function as the bonding layer. Therefore, it is possible to avoid more reliably formation of pinholes in the polyester skin due to such recesses, and the polyester skin can be reliably bonded to the liquid-contact surface of the core.

And, since the polyethylene bonding layer at the outer peripheral surface comprises a one layer, “creases” in the outer peripheral surface of the core can be reliably avoided and at the same time the polyester skin can be reliably bonded to the outer peripheral surface of the core.

According to the fourth characterizing feature of the present invention, in the container stopper described above, said polyester skin is a skin made of polyethylene terephthalate.

With the fourth characterizing feature of the present invention, said polyester skin is a skin made of polyethylene terephthalate. Polyethylene terephthalate has a very high barrier performance, and can further reduce the possibility of adverse influences of the core and adverse influences on the core itself.

According to the fifth characterizing feature of the present invention, a method of manufacturing a container stopper comprising a core formed of an elastic material and having a liquid-contact surface and an outer peripheral surface continuous with the liquid-contact surface, the liquid-contact surface and the outer peripheral surface being coated with a skin made of a synthetic resin, wherein a polyester film of a polyester resin or a synthetic resin having a polyester resin as a main component thereof is used as said skin, the polyester film is stretched, and said core is press-fit in a heated state for extension, the polyester film and the liquid-contact surface and the outer peripheral surface of said core being bonded through a polyethylene bonding layer of a polyethylene resin or having a polyethylene resin as a main component thereof, which bonding layer has a greater thickness at a portion thereof corresponding to the liquid-contact surface than the other portions.

With the fifth characterizing feature of the present invention, a synthetic resin film of a polyester resin or a synthetic resin having a polyester resin as a main component thereof is used as the skin for coating the liquid-contact surface and the outer peripheral surface continuous with the liquid-contact surface of the core formed of an elastic material. Therefore, as described above in connection with the first characterizing feature, it is possible to prevent adverse influences on the contents by entry of various smells from outside the container and absorption and adsorption of the flavor of the contents.

And, the polyester film is stretched, and the core is press-fit in a heated state for extension. The film of a polyester resin or a synthetic resin having a polyester resin as a main component thereof is coated in contact with and firmly on the liquid-contact surface and outer peripheral surface of the core. Hence, the polyester film as the skin of the container stopper can be firmly bonded to the liquid-contact surface and the outer peripheral surface of the core.

In addition, since the polyethylene bonding layer for boding the polyester film to the core has a greater thickness at a portion thereof corresponding to the liquid-contact surface than the other portions, as described hereinbefore, even where there exist fine recesses in the liquid-contact surface of the core, only a portion of the polyethylene bonding layer corresponding to the liquid-contact surface will enter the recesses and the polyester film as the skin will be free from formation of pinholes in the liquid-contact surface or “creases” in the outer peripheral face, so that the film can be firmly bonded to the core.

As a result, as described hereinbefore in connection with the first characterizing feature, the liquid-contact surface and the outer peripheral surface of the core may be coated with the skin made of a polyester resin without impairing the functions required of the container stopper. This prevents adverse influences on the contents by entry of various smells from outside the container and absorption and adsorption of the flavor of the contents, as well as adverse influences of the core, as noted hereinbefore. Even where the content includes alcohol, alcohol barrier characteristics of the polyester resin can prevent diffusion of core components to alcohol, to prevent a volume reduction of the core.

According to the sixth characterizing feature of the present invention, in the method of manufacturing a container stopper described above, a polyester skin having a skin-side polyethylene adhesion forming layer bonded to an inner surface thereof is used as said skin, and a core having a core-side polyethylene adhesion forming layer bonded to a liquid-contact surface and an outer peripheral surface thereof is used as said core, said skin-side and core-side polyethylene adhesion forming layers being integrated by thermal fusion to form said polyethylene bonding layer.

With the sixth characterizing feature of the present invention, a polyester skin having a skin-side polyethylene adhesion forming layer bonded to an inner surface thereof is used as said skin, and a core having a core-side polyethylene adhesion forming layer bonded to a liquid-contact surface and an outer peripheral surface thereof is used as said core, said skin-side and core-side polyethylene adhesion forming layers being integrated by thermal fusion to form said polyethylene bonding layer. Therefore, the bonding between the core and the polyester skin can be effected more reliably.

For example, where natural cork or compressed cork is used as the core, a polyester resin does not necessarily have good adhesion to the cork. By bonding polyethylene adhesion forming layers to the cork core and the polyester skin beforehand, and integrating the two adhesion forming layers by thermal fusion, even where the core is formed of cork, the core and the polyester skin are bonded reliably.

According to the seventh characterizing feature of the present invention, in the method of manufacturing a container stopper described above, the core-side polyethylene adhesion forming layer comprises at least two films including a first film corresponding to the liquid-contact surface and a second film corresponding to the liquid-contact surface and the outer peripheral face.

With the seventh characterizing feature of the present invention, the core-side polyethylene adhesion forming layer comprises at least two films including a first film corresponding to the liquid-contact surface and a second film corresponding to the liquid-contact surface and the outer peripheral face. Therefore, even where there exist fine recesses in the liquid-contact surface of the core, the first film will enter the recesses whereas the second film can provide its original function as the bonding layer. Therefore, it is possible to avoid formation of pinholes in the polyester skin in the liquid-contact surface and to avoid formation of “creases” in the outer peripheral face of the core, and the polyester skin can be reliably bonded to the outer peripheral face of the core.

According to the eighth characterizing feature of the present invention, in the method of manufacturing a container stopper described above, after the first film is bonded to the liquid-contact surface of the core, the second film is bonded to the liquid-contact surface and the outer peripheral surface of the core, thereby to form the core-side polyethylene adhesion forming layer.

With the eighth characterizing feature of the present invention, since the first film is bonded first to the liquid-contact surface of the core, the first film can be fixed in position in a reliable manner relative to the liquid-contact surface. And, as the second film is bonded subsequently to the core to which the first film has been bonded, the core-side polyethylene adhesion forming layer can be formed reliably. Further, since the bonded portion between the first film and the second film does not appear at the thermally fused portion between the core-side polyethylene adhesion forming layer and the skin-side polyethylene adhesion forming layer, the thermal fusion between the skin-side polyethylene adhesion forming layer and the core-side polyethylene adhesion forming layer can take place more integral manner. As a result, bonding between the core and the polyester skin can be even more reliable.

According to the ninth characterizing feature of the present invention, in the method of manufacturing a container stopper described above, a polyester skin having the skin-side adhesion forming layer of polyethylene bonded to an inner surface thereof by a dry laminate method is used as said skin.

With the ninth characterizing feature of the present invention, since a polyester skin having the skin-side adhesion forming layer of polyethylene bonded to an inner surface thereof by a dry laminate method is used as said skin, the polyester skin and the skin-side adhesion forming layer are bonded reliably and firmly. As a result, the polyester skin and the core are bonded reliably and firmly.

### BEST MODE OF EMBODYING THE INVENTION

An embodiment of this invention regarding container stoppers and a manufacturing method therefor will be described with reference to the drawings. It is understood that the present invention is not to be limited to the embodiment described next or to the constructions shown in the drawings.

Container stoppers of this invention are intended for closing openings of glass or ceramic containers containing liquids including various alcoholic drinks such as whiskey and wine, and other drinks and cosmetics. A stopper for whiskey, as shown in FIGS. 1 and 2, for example, includes a circular core 1 section formed of natural cork or compressed cork which is an example of elastic materials, and having a chamfer 1a at a tip portion and an inner mounting hole 1b. A liquid-contact surface F1 and an outer peripheral surface F2 continuous with the liquid-contact surface F1 of the core 1 are coated with a skin 2 of polyethylene terephthalate (PET), which is an example of polyester resins, having a thickness of about 8-20 μm.

As the skin 2 for coating the core 1, the polyethylene terephthalate used, preferably, is an amorphous, relatively flexible polyethylene terephthalate treated against crystallization by copolymerization with a third component such as 1,4-cyclohexane dimethanol or isophthalic acid. The skin 2 of polyethylene terephthalate is bonded all over the liquid-contact surface F1 and outer peripheral surface F2 of the core 1 through a bonding layer 3.

As shown in FIG. 3, the bonding layer 3 mainly comprises a polyethylene layer, and the polyethylene layer includes an inner-side polyethylene adhesive film 4, an outer-side polyethylene adhesive film 5 and a polyethylene film 6 arranged in order from adjacent the core 1. Further, as to the outer peripheral surface F2, this comprises a construction excluding the inner-side polyethylene adhesive film 4 from the liquid-contact surface, i.e. comprises the outer-side polyethylene adhesive film 5 and the polyethylene film 6 and an urethane adhesive 7 is interposed between the polyethylene film 6 and the skin 2 of polyethylene terephthalate.

The inner-side polyethylene adhesive film 4 and the outer-side polyethylene adhesive film 5 can be an acid-denatured polyolefin compound. Also, the polyethylene film 6 can be a low-density polyethylene, a linear low-density polyethylene or a high-density polyethylene. However, with regard to improvement of elasticity, it is preferred to employ a low-density polyethylene or a linear low-density polyethylene. Further, it is also possible to employ polyethylene having mechanical strength enhanced by metallocene catalyst.

Further, except a portion of the skin 2 of polyethylene terephthalate, i.e. a portion of the skin 2 located on the outer peripheral surface F2 of the core 1, specifically the portion on the chamfer 1a, the outer surface of the tip portion of the core 1 is coated with silicone 8 over a width indicated by “L” in FIG. 2, in order to be smoothly slidable relative to the opening of a container not shown.

The coating of silicone 8 on the skin 2 of polyethylene terephthalate may easily be formed by applying the silicone 8 after surface treatment by corona treatment or plasma treatment of the surface of the skin 2 of polyethylene terephthalate. In this case, it is more desirable to add and apply a lubricant to the silicone 8 than to apply the silicone 8 alone.

However, this silicone 8 is for improving slipperiness relative to the opening of the container, thereby to ensure smooth insertion/removal of the container stopper. Therefore, this is not absolutely needed.

If the skin of silicone 8 is to be provided, then, the lubricant to be added thereto, preferably, is one or more substances selected from fatty acid amides, polyhydric alcohol fatty acid esters and their derivatives, particulate polyethylene lubricants, or silicone particles. The fatty acid amides include, for example, oleic acid amide, erucic acid amide, behenic acid amide, stearic acid amide and so on. The polyhydric alcohol fatty acid esters and their derivatives include, for example, sorbitan monooleate, sorbitan monostearate, sorbitan trioleate and so on.

The stopper for whiskey is formed by inserting a projection 9a projecting from a glass umbrella 9 into the mounting hole 1b of the core 1, attaching the glass umbrella 9 to the upper end of the core 1 by an adhesive 10, and covering the contact portion of the upper end of the core 1 and the undersurface of the glass umbrella 9 with a washer seal 11 made of a synthetic resin.

To manufacture such a stopper for whiskey, as shown in FIG. 4, there are employed the inner-side polyethylene adhesive film 4 as a first polyethylene film corresponding to the liquid-contact surface F1, the outer-side polyethylene adhesive film 5 as a second film polyethylene film corresponding to the liquid-contact surface F1 and the outer peripheral surface F2, the polyethylene film 6 and a film 2a of polyethylene terephthalate used as the skin 2 of polyethylene terephthalate. The polyethylene film 6 is bonded to the inner surface of the film 2a of polyethylene terephthalate with the urethane adhesive 7 by a dry laminate method beforehand.

With using such films as above, first, as shown in FIG. 5, the inner-side polyethylene adhesive film 4 and the core 1 are pressed against a hot plate 12 which has a shape corresponding to the liquid-contact surface F1 of the core 1 and which also has been heated to about 130° C., thereby to bond the inner-side polyethylene adhesive film 4 to the liquid-contact surface F1 of the core 1. Then, as shown in FIG. 6, the outer-side polyethylene adhesive film 5 is bonded by thermal fusion to the liquid-contact surface F1 and outer peripheral surface F2 of the core 1.

Next, as shown in FIG. 7, the laminated film consisting of the film 2a of polyethylene terephthalate and the polyethylene film 6 is stretched, pressed down at peripheries thereof, and placed in a heated state over the core 1, and the core 1 is pressed into a die 13 of smaller diameter than the outside diameter of the core 1.

With this, the inner-side polyethylene adhesive film 4, the outer-side polyethylene adhesive film 5, the polyethylene film 6 and the polyethylene terephthalate film 2a are heat fused, whereby as shown in FIG. 3, the outer-side polyethylene adhesive film 5, and the polyethylene film 6 are integrated together to form the polyethylene bonding layer 3, and the polyethylene terephthalate film 2a is formed into the polyethylene terephthalate skin 2, with this polyethylene terephthalate film 2a being firmly bonded to the entire liquid-contact surface F1 and the outer peripheral surface 2 of the core 2.

At the same time, if there exist fine recesses unique to the cork in the liquid-contact surface F1 of the core, since the inner-side polyethylene adhesive film 4 is fused and diffused into such recesses, formation of pinholes in the polyester skin 2 in the liquid-contact surface F1 can be avoided.

Thereafter, when the core 1 is removed from the die 13, due to the resilience of the core 1, the skin 2 of polyethylene terephthalate is engaged under the stretched condition onto the core 1. Subsequently, if needed, the outer surface of the tip portion of the core 1 is coated with the silicone 8, and the glass umbrella 9 and washer seal 11 are attached to the core 1.

Although not shown, with the stopper for whiskey, the inner peripheral surface and upper surface of the mounting hole 1b may also be completely coated with the skin 2 of polyethylene terephthalate. In this case, the core 1 will be completely sealed off from the exterior to eliminate adverse influences of the core 1 on the contents.

In order to confirm the effect of the invention, various experiments were conducted. Some of the experiments will be described with reference to FIG. 8.

Examples 1-4 and Comparison Examples 1-4 shown in FIG. 8 are results of determinations on container stoppers manufactured by the invention's method with using the inner-side polyethylene adhesive film 4, the outer-side polyethylene adhesive film 5 and the laminated film consisting of the polyethylene film 6 and the polyethylene terephthalate film 2a.

In these Examples and Comparison Examples, the inner-side polyethylene adhesive film 4 and the outer-side polyethylene adhesive film 5 have thicknesses respectively shown in FIG. 8 (in the tables, inner-side PE denotes the inner-side polyethylene adhesive film and outer-side PE denotes the outer-side polyethylene adhesive film, respectively). In Comparison Example 1 and Comparison Example 4, the inner-side polyethylene adhesive film 4 was not used.

Also, in these Examples and Comparison Examples, the same laminated film consisting of the polyethylene film 6 and the polyethylene terephthalate film 2a was used. Specifically, the laminated film used consists of the polyethylene film 6 of 70 μm and the polyethylene terephthalate film 2a of 20 μm.

And, according to the above-described manufacturing method, four container stoppers were manufactured and the thickness of the polyethylene adhesive layer (shown at PE in the table), the thickness of the polyester skin (shown at PET in table) and the total thickness of PE and PET were determined. Also, by penetration tests, presence/absence of pinholes in the liquid-contact surface of the core was detected and by leak tests, presence/absence of “creases” in the outer peripheral surface F2 was detected. Observations of the outer appearances were also made.

Referring to the specific evaluation method used in the respective experiments, for the penetration tests, each sample stopper was pushed into a bottle filled with a liquid and then stored for one week at 45° C. Then, any penetration was visually evaluated. If no penetration of the liquid into the cork, a mark ◯ was given. If penetration was found, a mark x was given.

In the leak tests, each sample stopper was pushed into a bottle filled with a liquid and then stored for one week at 45° C. Then, an amount of leak was calculated from any decrease in the weight. A mark ◯ was given if the liquid leak amount was below 0.03 g, whereas a mark x was given if the liquid leak amount was 0.03 g or more.

Further, the appearance was visually evaluated. If the cork was clearly visible with absence of unevenness on its surface, a mark ◯ was given, whereas if there was surface unevenness or the cork was not clearly visible, a mark x was given.

In the determinations of the thicknesses of PE and PET, as shown in the left-upper diagram in FIG. 8, a plurality of determinations were made at six portions denoted with A-F and an average value thereof was obtained. Incidentally, in these experiments, the thicknesses of PE and PET were determined by using a super-depth determining microscope VK8500 from KEYENCE Corporation, with 1000 times magnification of the sample section.

A is a center portion of the liquid-contact surface F1, that is, a portion of the liquid-contact surface F1, excluding the chamfer 1a, B is an interface portion between the chamfer 1a and the center portion A. C is a portion substantially at the center of the chamfer 1a. D is an interface between the chamfer 1a and the outer peripheral surface 2. E is a portion of the outer peripheral surface F2 toward the liquid-contact surface F1, that is, a portion of the outer peripheral surface F2 adjacent the chamfer 1a. F is an outer peripheral portion of the outer peripheral surface F2 away from the liquid-contact surface F1.

From these experiment results, the following facts were found.

(a) Regarding the PE thickness at the center portion A of the liquid-contact surface, in Comparison Example 1, the thickness was 69 μm and penetration due to formation of pinhole was observed. Whereas, in Example 1, the thickness was 90 μm and no penetration was observed. Therefore, it is believed that the lower limit of the PE thickness at the center portion A is about 80 μm.

Further, in Comparison Example 2, with the PE thickness of 312 μm, there was non-transparency, so the core cork was not clearly visible, indicating deterioration of commercial value. Whereas, in Example 4, with the thickness of 281 μm, the cork was clearly visible. Therefore, it is believed that the upper limit of PE thickness at the center portion A is about 300 μm.

From these results, the PE thickness needs to be set from 80 to 300 μm at the center portion A of the liquid-contact surface.

(b) Regarding the PE thickness at the outer peripheral portion E of the outer peripheral surface toward the liquid-contact surface, in Comparison Example 3, with thickness of 65 μm, appearance defect due to unevenness formation was observed. Whereas, in Example 2, with thickness of 72 μm, no appearance defect was observed. Therefore, it is believed that the lower limit of the PE thickness at the outer peripheral portion E is about 70 μm.

Further, in Comparison Example 4, with thickness of 117 μm, leak due to formation of “creases” was confirmed. Whereas, in Example 4, with thickness of 96 μm, no leak was found. Therefore, it is believed that the upper limit of PE thickness at the outer peripheral portion E is about 100 μm.

From these results, the PE thickness needs to be set from 70 to 100 μm at the outer peripheral portion E of the outer peripheral surface toward the liquid-contact surface.

(c) Regarding the PE thickness over the entire liquid-contact surface, that is, the center portion A of the liquid-contact surface, the interface portion B between the center portion A and the chamfer, and the substantial center portion C of the chamber, in Comparison Example 1, with thickness of 24 μm at the interface portion B, penetration due to formation of pinhole was found. Based on this, it is understood that the PE layer thickness needs to exceed a predetermined value in the liquid-contact surface. And, considering also the size of recesses in the surface of the cork, it is needed that the PE thickness be set at 30 μm or greater over the entire surface.

(d) Regarding the relationship between the PE layer thickness at the center portion A and that at the outer peripheral portion E, in Comparison Example 1, the thickness was 69 μm at the center portion A and 74 μm at the outer peripheral portion E, the thickness at the outer peripheral portion E being greater and penetration was observed. Therefore, it is preferred that the layer thickness at the center portion A be set greater than that at the outer peripheral portion E.

On the other hand, if the layer thickness at the center portion A is set excessively greater that that at the outer peripheral portion E, this will cause a problem in the appearance also as well as cost inefficiency.

In Example 1, the thicknesses were 90 μm and 74 μm, respectively, the layer thickness at the center portion A being 16 μm greater, and no penetration or leak was observed and there was also no appearance problem, either. Therefore, it is preferred that the PE layer thickness at the center portion A be set 10 μm or more greater than the layer thickness at the outer peripheral portion E.

Incidentally, microscope observations on the comparison examples where penetration was observed and the inner-side polyethylene adhesive film was not used reveled presence of pinholes.

Referring to the pinholes PH, as shown in the diagram of FIG. 9, when there existed a fine recess unique to the cork in the surface of the cork 1, the skin 2 and the adhesive layer 3 lacking any inner-side polyethylene adhesive 4 which had been under a condition shown in (a) immediately after the molding were drawn, by a suction effect associated with cooling, into the recess 14 as shown in (b), so that a small hole was formed not only in the bonding layer 3, but also in the skin 2.

On the other hand, in the case of the Examples, as shown in FIG. 10 (a) and (b), even where the recess 14 was present, since the inner-side polyethylene adhesive film 4 was fused and diffused into the recess 14, so no hole was formed at least in the skin 2. And, this difference was confirmed through the microscopic observation.

### OTHER EMBODIMENTS

(1) In the foregoing embodiment, there was described a stopper for whisky as an example of the container stopper. However, the container stopper and its manufacturing method relating to the present invention are applicable also to a stopper for closing an opening of containers made of glass or ceramics, for wine, various alcoholic or non-alcoholic drinks or various kinds of liquids such as cosmetics.

Further, in the foregoing embodiment, the core 1 is formed of natural cork or compressed cork. Apart from cork, various elastic materials having appropriate elasticity required for the core of a stopper for a container may be used, which include natural rubber, synthetic rubber, molding of wood chips, a polyester resin, and a synthetic resin having a polyester resin as a main component thereof.

(2) Regarding the polyester skin 2, an example was shown and described as being formed of polyethylene terephthalate which is one example of polyester resins. Apart from this, polybutylene terephthalate, polyester resins such as thermoplastic polyester elastomer, and various synthetic resins having polyester resins as main components thereof, may be used.

Further, in manufacturing the container stopper, in the foregoing embodiment the polyethylene film comprised the two films of the inner-side first film 4 and the outer-side second film 5, with the second film 5 being bonded after bonding of the first film 4. Instead, the film can be formed simultaneously by placing the first film 4 on the second film 5 and bonding them together. Further, the film can be manufactured by using a single film having a greater thickness at the portion corresponding to the liquid-contact surface F1 than the portion thereof corresponding to the outer peripheral surface F2.

### INDUSTRIAL UTILITY

The container stoppers and the manufacturing method therefor according to this invention are applicable as container stoppers for closing openings of glass or ceramic containers containing various alcoholic drinks such as whiskey and wine, various non-alcoholic drinks, and various liquids such as cosmetics, and as methods of manufacturing the container stoppers.

### BRIEF DESCRIPTION OF THE DRAWINGS

FIG. 1 is an exploded perspective view of a stopper for whiskey,

FIG. 2 is a view, partly in section, of the stopper for whiskey,

FIG. 3 is an enlarged sectional view of a principal portion of the stopper for whiskey,

FIG. 4 is a sectional view of a film used in the manufacture of the stopper of whiskey,

FIG. 5 is a sectional view showing a process of manufacturing the stopper for whiskey,

FIG. 5 is a sectional view showing the process of manufacturing the stopper for whiskey,

FIG. 6 is a sectional view showing the process of manufacturing the stopper for whiskey,

FIG. 7 is a perspective view showing the process of manufacturing the stopper for whiskey,

FIG. 8 is a table showing results of experiments conducted for confirming the effects,

FIG. 9 is a diagram illustrating a mechanism by which pinholes are formed, and

FIG. 10 is a diagram illustrating a mechanism by which pinholes are not formed.

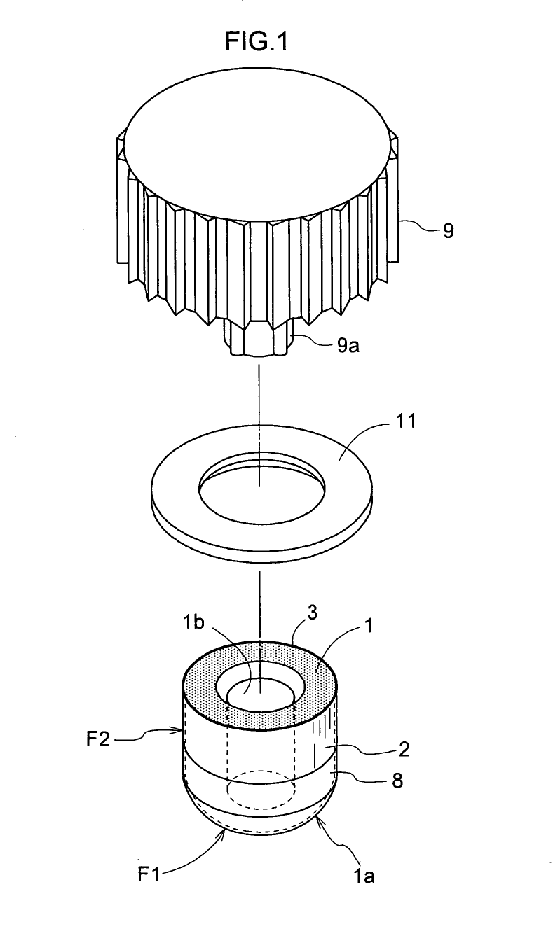

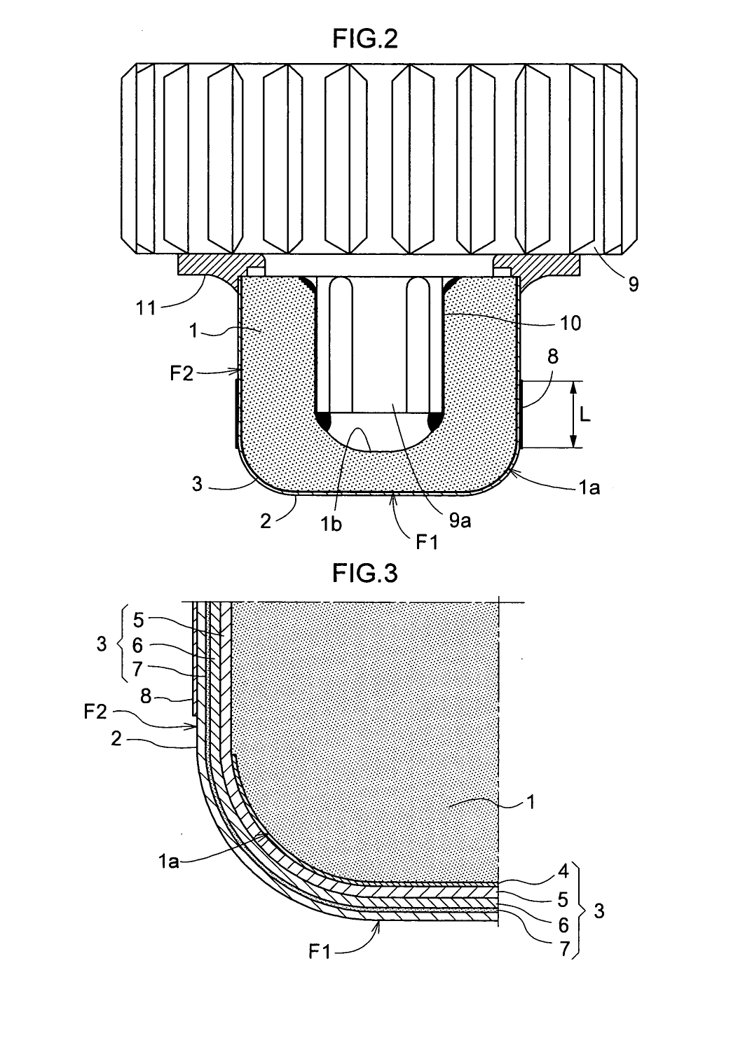

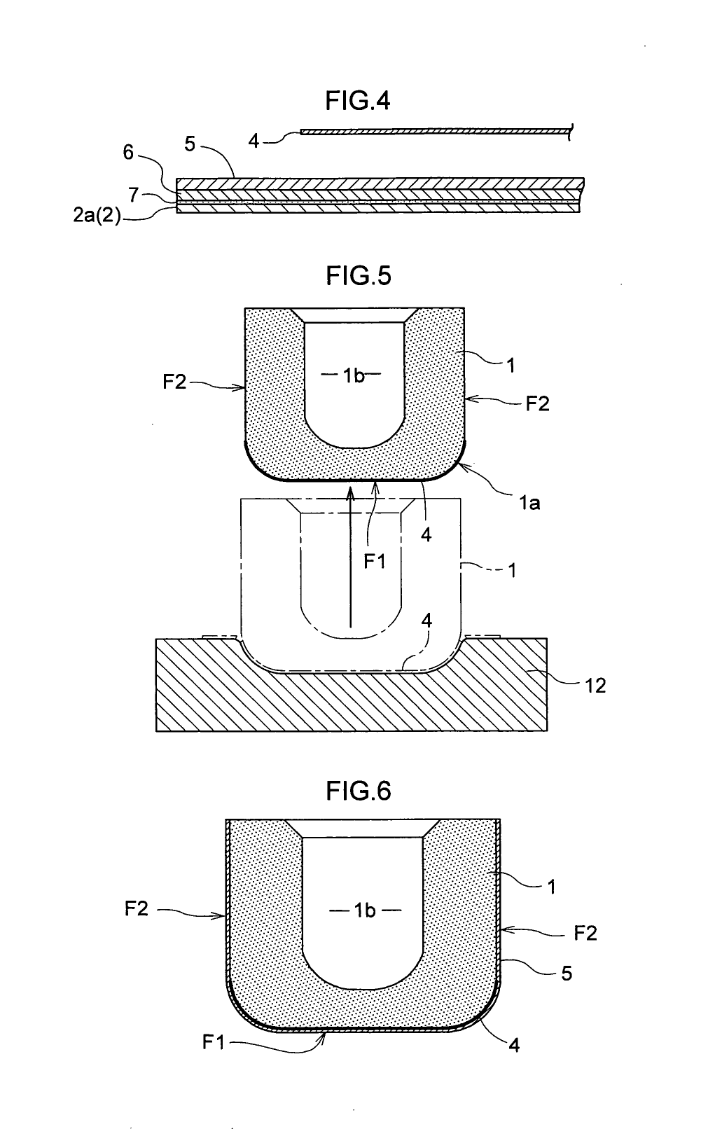

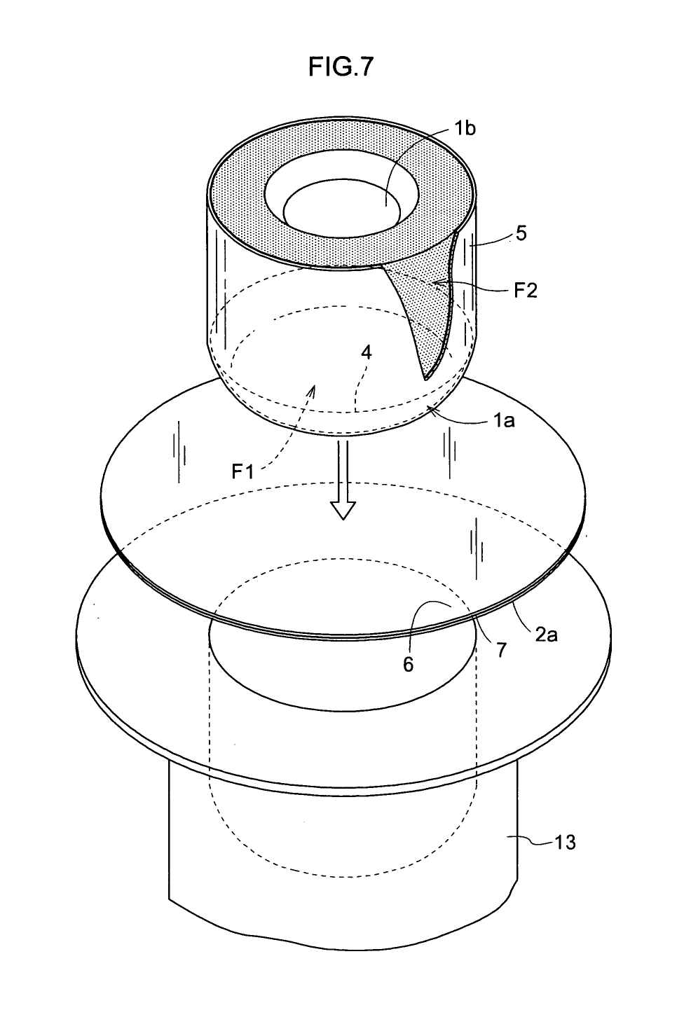

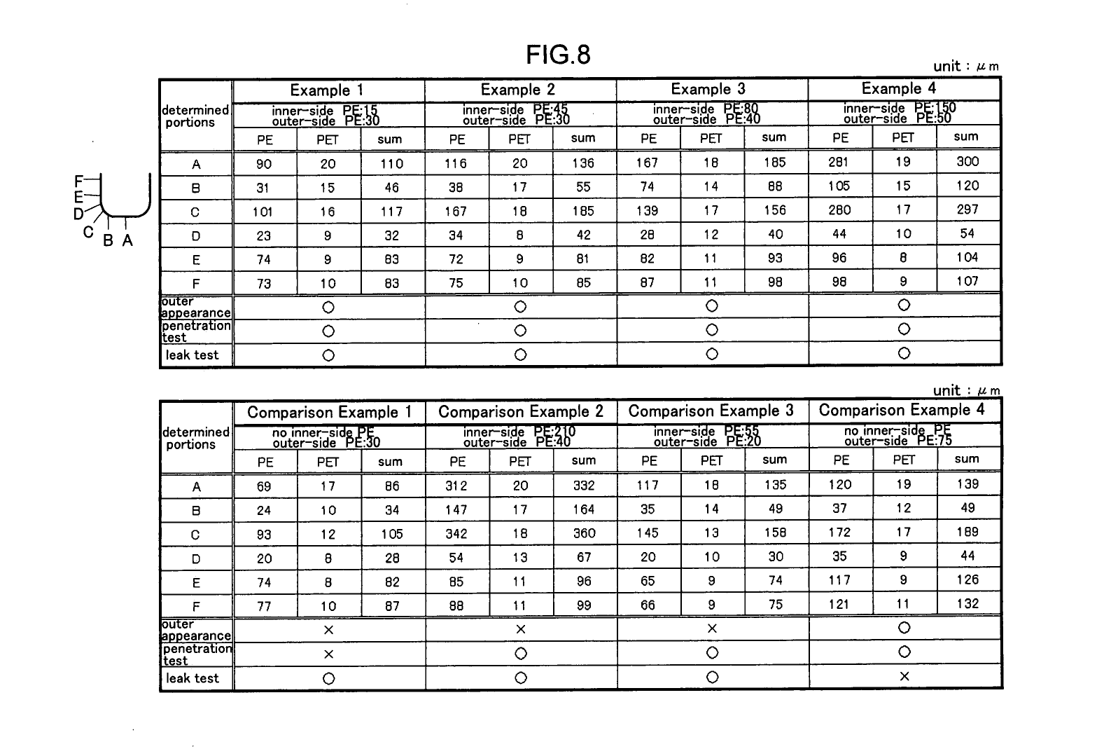

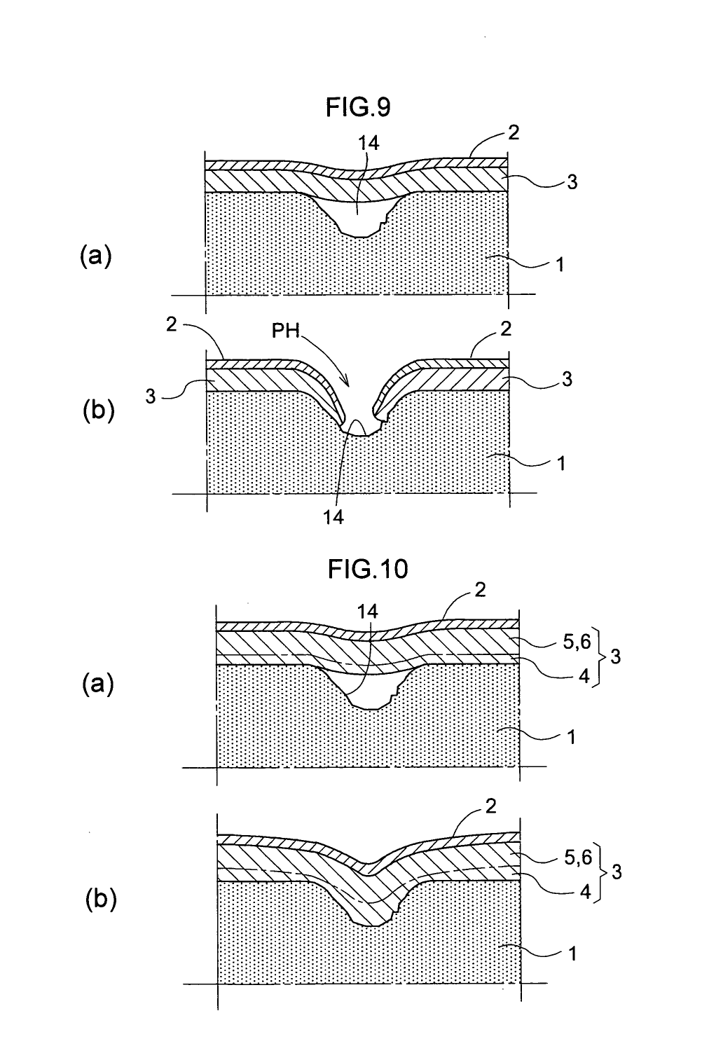

### DESCRIPTION OF REFERENCE SIGNS

1 core
2 polyester skin
2a polyester film
3 bounding layer
4 first polyethylene films
5 second first polyethylene films
A middle portion of a liquid-contact surface
E portion of the outer peripheral surface toward the liquid-contact surface
F1 liquid-contact surface
F2 outer peripheral surface

1: A container stopper comprising a core formed of an elastic material and having a liquid-contact surface and an outer peripheral surface continuous with the liquid-contact surface, the liquid-contact surface and the outer peripheral surface being coated with a skin made of a synthetic resin;
wherein said skin is a polyester skin made of a polyester resin or a synthetic resin having a polyester resin as a main component thereof, and the polyester skin is bonded to the liquid-contact surface and the outer peripheral surface of said core through a polyethylene bonding layer formed of a polyethylene resin or having a polyethylene resin as a main component thereof; and said polyethylene bonding layer has a thickness of 80 to 300 μm at a center portion of the liquid-contact surface, a thickness of 70 to 100 μm at an outer peripheral portion of the outer peripheral surface adjacent the liquid-contact surface and a thickness of 30 μm or more over the entire liquid-contact surface.

2: The container stopper according to claim 1, wherein the thickness of said polyethylene bonding layer is 10 μm or more greater than the thickness of the polyethylene bonding layer at the outer peripheral portion.

3: The container stopper according to claim 1, wherein the polyethylene bonding layer at the liquid-contact surface comprises two layers and the polyethylene bonding layer at the outer peripheral surface comprises a one layer.

4: The container stopper according to claim 1, wherein said polyester skin is a skin made of polyethylene terephthalate.

5: A method of manufacturing a container stopper comprising a core formed of an elastic material and having a liquid-contact surface and an outer peripheral surface continuous with the liquid-contact surface, the liquid-contact surface and the outer peripheral surface being coated with a skin made of a synthetic resin, wherein the method comprises the steps of:
using a polyester film of a polyester resin or a synthetic resin having a polyester resin as a main component thereof as said skin;
stretching the polyester film;
press fitting the core in a heated state for extension;
bonding the polyester film and the liquid-contact surface and the outer peripheral surface of said core through a polyethylene bonding layer of a polyethylene resin or having a polyethylene resin as a main component thereof, wherein the bonding layer has a greater thickness at a portion thereof corresponding to the liquid-contact surface than the other portions.

6: The method according to claim 5, further comprising the steps of:
using a polyester skin having a skin-side polyethylene adhesion forming layer bonded to an inner surface thereof as said skin;
using a core having a core-side polyethylene adhesion forming layer bonded to a liquid-contact surface and an outer peripheral surface thereof as said core; and
integrating said skin-side and core-side polyethylene adhesion forming layers by thermal fusion to form said polyethylene bonding layer.

7: The method according to claim 6, wherein the core-side polyethylene adhesion forming layer comprises at least two films including a first film corresponding to the liquid-contact surface and a second film corresponding to the liquid-contact surface and the outer peripheral face.

8: The method according to claim 7, further comprising the step of:
bonding the second film to the liquid-contact surface and the outer peripheral surface of the core after bonding the first film to the liquid-contact surface of the core, whereby the core-side polyethylene adhesion forming layer is formed.

9: The method according to claim 6, wherein said skin is a polyester skin having the skin-side adhesion forming layer of polyethylene bonded to an inner surface thereof by a dry laminate method.
